(19) United States
(12) Patent Application Publication
(10) Pub. No.: US 2017/0122476 A1
(43) Pub. Date: May 4, 2017

(54) MICROWAVE-BASED FLUID CONDUIT HEATING SYSTEM AND METHOD OF OPERATING THE SAME

(71) Applicant: General Electric Company, Schenectady, NY (US)

(72) Inventors: Carlos Enrique Diaz, Munich (DE); Selaka Bandara Bulumulla, Niskayuna, NY (US); Claudia Martins da Silva, Stabekk (NO)

(21) Appl. No.: 14/925,313

(22) Filed: Oct. 28, 2015

(51) Int. Cl. F16L 53/00; H05B 6/80; H05B 6/70; H05B 6/64

(52) U.S. Cl. CPC F16L 53/004; H05B 6/6447; H05B 6/802; H05B 6/708

(57) ABSTRACT

A fluid conduit heating system includes a fluid transport conduit including a wall including a radially inner surface and a radially outer surface. The radially inner surface has a predetermined topography and the fluid transport conduit is configured to transport a hydrocarbon fluid therethrough. The system also includes a microwave heating device in radio frequency (RF) communication with the fluid transport conduit. The microwave heating device includes a microwave generator configured to generate microwave radiation and a waveguide coupled to the microwave generator. The waveguide is configured to conform a propagation pattern of the microwave radiation generated by the microwave generator to the predetermined topography of the radially inner surface.

### BACKGROUND

The field of the disclosure relates generally to fluid conduit systems and, more particularly, to microwave-based fluid conduit heating systems.

At least some of known hydrocarbon fluid conduits include gas pipelines, e.g., subsea natural gas pipelines. Many of these known subsea natural gas pipelines extend long distances, i.e., in excess of five miles (8 kilometers) in low-temperature environments and such subsea pipelines are therefore susceptible to deposit buildups on the inside walls of the pipelines. Such deposits include hydrates, i.e., any compound containing water in the form of H₂O molecules. Natural gas transported through such pipelines typically includes less than 5 mole percent (%) polar water molecules and over 95% methane molecules, and the gas is sometimes referred to as “wet gas”. These hydrates tend to freeze and restrict the natural gas flow through the pipeline. Other known deposits include wax, asphaltenes, i.e., molecular substances found in crude oil, and scale deposits. These other deposits may also restrict flow through the pipeline, and also completely block the pipeline.

At least some known methods of mitigating deposition on the inner pipeline walls include chemical-based methods including an inhibitor to melt and/or prevent the formation of these deposits. Such chemical inhibitors modify the hydrate phase equilibria through lowering the hydrate formation temperature below the normal formation temperature and raising the hydrate formation pressure above the normal formation pressure. However, such inhibitors may change from liquid phase to vapor phase where it is less effective in inhibiting hydrate formation, may induce piping corrosion, and incur large attendant costs of using such consumable chemicals. Other known chemical inhibitors are low dosage hydrate inhibitors such as kinetic inhibitors that delay hydrate nucleation and growth for periods possibly longer than the residence time of the hydrocarbons in the pipeline. However, they are only effective in moderate sub-cooling environments, i.e., when the hydrate equilibrium temperature minus a typical deep water temperature is approximately 13 degrees Celsius (° C.) (23 degrees Fahrenheit (° F.)). Other known low dosage hydrate inhibitors include anti-agglomerants that prevent hydrate crystals from agglomerating into hydrate plugs in pipelines exposed to environments where the sub-cooling is more extreme, i.e., 22° C. (40° F.). However, both chemicals require purchase, storage, and replenishment, thereby incurring increased costs of pipeline construction and operational costs. Some of these chemicals have characteristics that require special handling and disposal methods, thereby further increasing operational expenses.

Known non-chemical methods of mitigating hydrate formation inside hydrocarbon pipelines include direct electric heating through coupling electric current-carrying wires to the external surface of the pipeline. Such known non-chemical methods also include standard trace-heating through coupling a series of layers of electric current-carrying cables and insulation over the pipeline. Such known non-chemical methods further include skin-effect heat tracing through coupling a heat tube to the outside piping surface, extending a current-carrying conductor through the heat tube, and wiring a first voltage source to the heat tube and ground (e.g., the outside surface of the pipeline) and wiring a second voltage source to the heat tube and the current-carrying conductor. Each of these known non-chemical methods requires significant lengths of wiring, cabling, and insulation, and significant consumption of electricity. Moreover, these methods also tend to heat the water around the pipeline, thereby wasting a large amount of energy. Furthermore, the direct electric heating system tends to inject electric current into the surrounding seawater, therefore further decreasing the efficiency of the system. Another known non-chemical method includes hot water circulation where one or more hot water supply and return tubes extend proximate to gas transport piping through an insulated pipeline system. However, the additional supply and return piping significantly increases the costs and complexity of such designs and the hot water supply and return pipes are susceptible to freezing if out of service for a period of time in those cold environments.

### BRIEF DESCRIPTION

In one aspect, a fluid conduit heating system is provided. The system includes a fluid transport conduit including a wall including a radially inner surface and a radially outer surface. The radially inner surface has a predetermined topography and the fluid transport conduit is configured to transport a hydrocarbon fluid therethrough. The system also includes a microwave heating device in radio frequency (RF) communication with the fluid transport conduit. The microwave heating device includes a microwave generator configured to generate microwave radiation and a waveguide coupled to the microwave generator. The waveguide is configured to conform a propagation pattern of the microwave radiation generated by the microwave generator to the predetermined topography of the radially inner surface.

In a further aspect, a method of deposit removal and deposit inhibition in a fluid transport conduit is provided. The fluid transport conduit includes a wall including a radially inner surface having a predetermined topography. The fluid transport conduit is configured for subsea operation and further configured to transport a hydrocarbon fluid therethrough. The method includes coupling a microwave heating device in radio frequency (RF) communication with the fluid transport conduit and generating microwave radiation through the microwave heating device. The method also includes conforming a propagation pattern of the microwave radiation generated by the microwave heating device to the predetermined topography of the radially inner surface and launching the microwave radiation into the fluid transport conduit.

In another aspect, a subsea hydrocarbon fluid transfer system is provided. The subsea hydrocarbon fluid transfer system includes a plurality of fluid transport conduits coupled in flow communication. Each fluid transport conduit of the plurality of fluid transport conduits includes a conduit wall including a radially inner conduit surface and a radially outer conduit surface. The radially inner conduit surface has a predetermined topography. Each fluid transport conduit is configured to transport a hydrocarbon fluid therethrough. The subsea hydrocarbon fluid transfer system also includes a microwave-based fluid conduit heating system including a plurality of microwave heating devices in radio frequency (RF) communication with at least a portion of the fluid transport conduits. Each microwave heating device of the plurality of microwave heating devices includes a microwave generator configured to generate microwave radiation a waveguide coupled to a respective microwave generator. The waveguide is configured to conform a propagation pattern of the microwave radiation generated by the respective microwave generator to the predetermined topography of the radially inner conduit surface.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic view of an exemplary portion of a subsea hydrocarbon fluid transfer system, i.e., a subsea pipeline;

FIG. 2 is a schematic view of an exemplary microwave-based fluid conduit heating system that may be used with the subsea hydrocarbon fluid transfer system shown in FIG. 1;

FIG. 3 is a schematic view of an alternative microwave-based fluid conduit heating system that may be used with the subsea hydrocarbon fluid transfer system shown in FIG. 1;

FIG. 4 is a schematic view of the principle of operation of the microwave-based fluid conduit heating systems shown in FIGS. 2 and 3;

FIG. 5 is a schematic view of an exemplary microwave heating device that may be used with the microwave-based fluid conduit heating system shown in FIG. 2;

FIG. 6 is a thermographic view of a portion of an exemplary radially inner surface of an exemplary fluid transport conduit having an exemplary topography;

FIG. 7 is a graphical view of a temperature profile of a cross-sectional view of the fluid transport conduit shown in FIG. 6;

FIG. 8 is a thermographic view of a portion of an exemplary radially outer surface of the fluid transport conduit shown in FIG. 6;

FIG. 9 is a schematic view of an exemplary waveguide mode converter that may be used with the microwave-based fluid conduit heating systems shown in FIGS. 2 and 3;

FIG. 10 is a schematic view of an alternative waveguide mode converter that may be used with the microwave-based fluid conduit heating systems shown in FIGS. 2 and 3;

FIG. 11 is a schematic overhead view of an exemplary perforated waveguide that may be used with the microwave-based fluid conduit heating system shown in FIG. 2;

FIG. 12 is a schematic perspective view of the perforated waveguide shown in FIG. 11;

FIG. 13 is a schematic view of an exemplary heat exchange device that may be used with the subsea hydrocarbon fluid transfer system shown in FIG. 1;

FIG. 14 is a schematic view of an alternative heat exchange device that may be used with the subsea hydrocarbon fluid transfer system shown in FIG. 1; and

FIG. 15 is a schematic view of another alternative heat exchange device that may be used with the subsea hydrocarbon fluid transfer system shown in FIG. 1.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

As used herein, the terms “processor” and “computer,” and related terms, e.g., “processing device,” “computing device,” and “controller” are not limited to just those integrated circuits referred to in the art as a computer, but broadly refers to a microcontroller, a microcomputer, a programmable logic controller (PLC), and application specific integrated circuit, and other programmable circuits, and these terms are used interchangeably herein. In the embodiments described herein, memory may include, but it not limited to, a computer-readable medium, such as a random access memory (RAM), a computer-readable non-volatile medium, such as a flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

The microwave heating devices, fluid conduit heating systems, and subsea hydrocarbon fluid transfer systems as described herein overcome a number of deficiencies associated with known systems and methods of reducing restrictions in subsea natural gas pipelines in low temperature environments, e.g., arctic regions such as, without limitation, the North Sea. Specifically, the fluid conduit heating systems use microwaves to heat water molecules in natural gas pipelines thus decreasing formation of hydrates in the pipelines. The microwaves propagate along the pipeline from an immersed microwave heating device. The metallic pipeline acts as an electromagnetic wave guide keeping the microwaves confined into the inner region of the pipeline, transporting the heating energy to the predetermined heating points, and facilitating microwave transmission through bends and other flow direction changes. The microwaves travel along the pipeline and heat the water molecules and the inner surface of the metallic pipeline. The heated polar water molecules cannot bond into the unheated, nonpolar methane molecules and the formation of hydrates is significantly reduced. In addition, the fluid conduit heating systems described herein may also be used to heat any other metallic fluid conduit heating system components, such as, and without limitation, the internal portions of heat exchangers used as anti-surge coolers prior to system start-up, manifolds, jumpers to the manifold, and piping connectors. The predetermined microwave frequencies will be selected based on factors that include, without limitation, pipeline diameters and the associated cutoff frequencies. In addition to reducing deposition of hydrates on the inner surfaces of the pipelines, such heating within the pipelines as described herein also facilitate decreasing deposits of wax, asphaltenes, and scale.

In addition, the microwave heating devices, fluid conduit heating systems, and subsea hydrocarbon fluid transfer systems as described herein improve the energy transfer from the microwave sources to the pipe and other metallic components through matching the impedances of the sources with the impedances of the components either manually or through automatic operation. In some embodiments, the microwave heating devices include a waveguide mode converter that facilitates, without limitation, transitioning a rectangular waveguide generating microwaves in the TE₁₀ (traverse electric) mode to a circular waveguide launching microwaves in the TE₁₁ mode to further enhance the energy efficiency of the fluid conduit heating systems described herein.

Also, in some embodiments, the microwave heating devices are positioned in fixed locations along the length of a gas pipeline. These fixed microwave heating devices are configured to channel natural gas through channels defined in the waveguides substantially uninterrupted while mitigating microwave leakage. Such fixed microwave heating devices facilitate continuous microwave launching during pipeline operation to maintain temperature of pipe above hydrate formation temperature, i.e., typically approximately 25 degrees Celsius (° C.) (77 degrees Fahrenheit (° F.)). Also, such fixed microwave heating devices facilitate deposit removal in the event that either restriction or blockage is determined to exist in the gas pipeline. In other embodiments, the microwave heating devices are implemented as a mobile system coupled to a pipeline pig that is translated through the pipeline. These mobile systems are also configured to facilitate continuous microwave launching during pipeline operation and facilitate deposit removal at the discretion of the operator.

Furthermore, to further enhance the energy efficiency of the fluid conduit heating systems, the heating of the pipeline wall is generated at the inner surface of the pipeline, i.e., not in region between the inner and outer pipeline surfaces, such that the temperature profile in the pipeline cross-section includes a highest temperature at the inner surface and the thermal losses into the surrounding subsea are mitigated. The pipeline has an insulation material as the outermost layer, such that heat generated in the inner part of the pipeline does not transfer out to the sea water. Moreover, for the pipelines with the predetermined inner wall surface topologies, e.g., internally corrugated, a change of the microwave frequency results in a change of the proportion of heat being transferred to the water molecules inside the pipeline compared to the amount of heat locally transferred to the metallic inner part of the pipeline, thereby facilitating heat transfer to the pipeline inner surface at particular predetermined points along the length of the pipeline.

Also, the fluid conduit heating systems described herein facilitate decreasing capital construction costs and operation and maintenance costs. For example, heating cables are not coupled to the length of the pipeline segments to be heated because the pipeline itself is used as a microwave waveguide. Also, for example, a significant decrease in energy transfer to the surrounding subsea environment is achieved. Furthermore, for example, there is little chance for inducing secondary currents outside of the pipeline in the subsea environment. Also, more economical exploration and resource recovery operations including natural gas pipelines in more severe cold operating conditions, such as sea floor pipelines under arctic conditions, is facilitated. Furthermore, design and operation of the heating systems described herein may be customized to facilitate particular environmental conditions at energy consumption levels particular to local heating requirements. In addition, in contrast to many known solutions, microwave heating may be easily retrofitted to existing resource recovery projects fields.

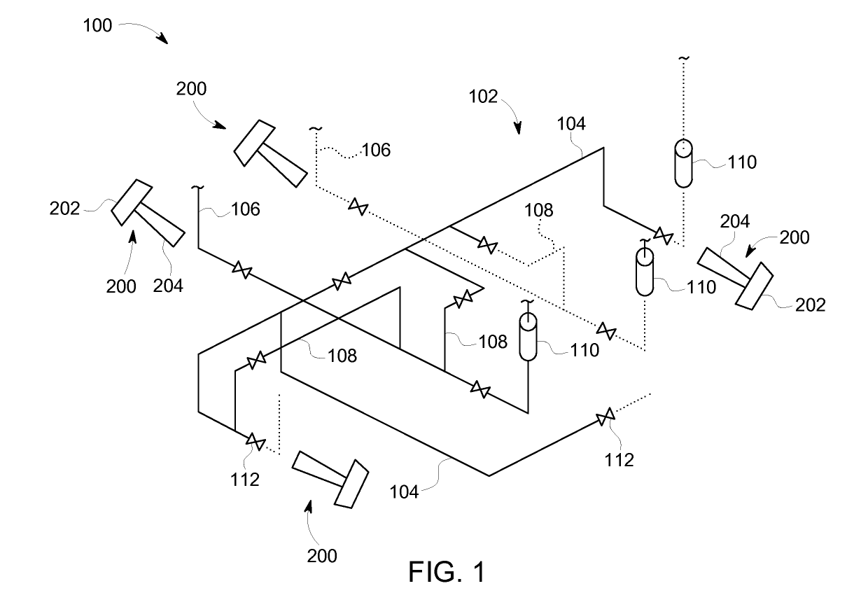

FIG. 1 is a schematic view of an exemplary portion of a subsea hydrocarbon fluid transfer system 100. In the exemplary embodiment, the portion of subsea hydrocarbon fluid transfer system 100 shown in FIG. 1 is a manifold 102 configured to transport hydrocarbon fluids, such as, without limitation, natural gas (not shown in FIG. 1). Manifold 102 includes a plurality of fluid transport conduits, i.e., pipeline segments 104 that further include a plurality of risers 106 in fluid communication with facilities that include, without limitation, a floating platform, a ship, and a land-based facility (neither shown). Pipeline segments 104 also include a plurality of jumpers 108, a plurality of piping couplers 110, and a plurality of valves 112. Manifold 102 further includes a plurality of microwave heating devices 200 in radio frequency (RF) communication with at least a portion of pipeline segments 104. Each microwave heating device 200 includes a microwave generator 202 configured to generate microwave radiation (not shown in FIG. 1) with a magnetron (not shown in FIG. 1) and a waveguide 204 (sometimes referred to as an antenna) coupled to microwave generator 202. Microwave heating device 200 is discussed further below.

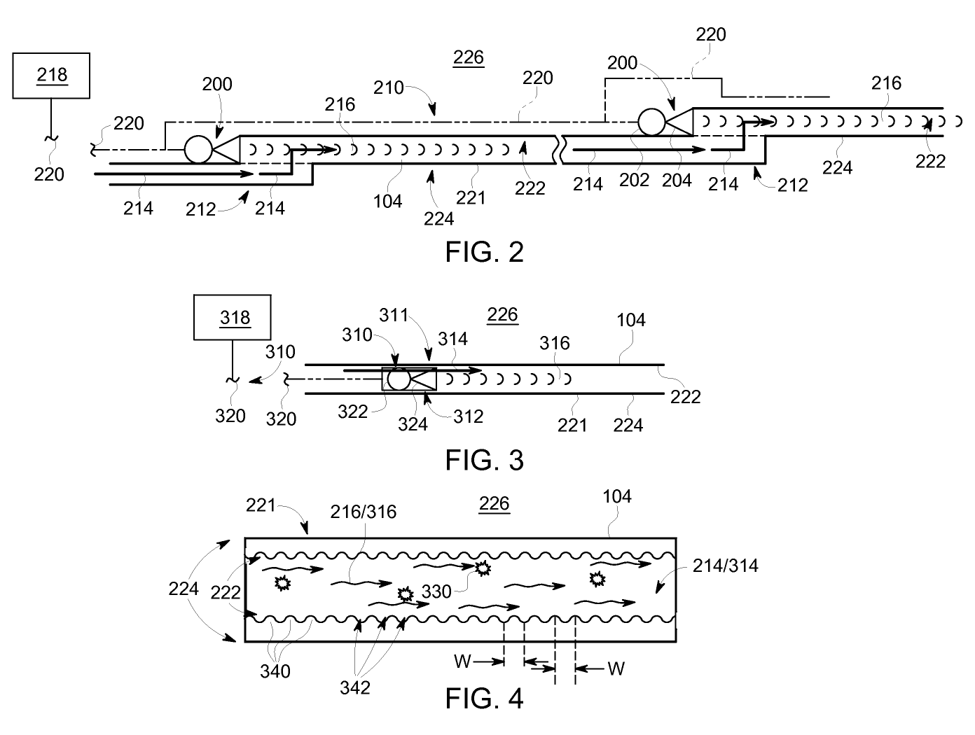

FIG. 2 is a schematic view of an exemplary microwave-based fluid conduit heating system 210 that may be used with subsea hydrocarbon fluid transfer system 100 (shown in FIG. 1). In the exemplary embodiment, a plurality of pipeline segments 104 each include a plurality of flow diverters 212 and microwave heating devices 200 proximate each other. Flow diverters 212 are configured to shift a flow of wet natural gas 214 such that each microwave heating device 200 is aligned with an associated pipeline segment 104 to conform a propagation pattern of microwave radiation 216 to a predetermined topography (not shown in FIG. 2 and discussed below) of a radially inner surface (discussed below) of pipeline segment 104. Flow diverters 212 are shown as sharp angular devices. Alternatively, flow diverters 212 have any configuration that enables operation of fluid conduit heating system 210 as described herein, including, without limitation, elbows. Also, each pipeline segment 104 is shown substantially linear in the longitudinal dimension. Alternatively, pipeline segments 104 have any configuration that enables operation of fluid conduit heating system 210 as described herein, including, without limitation, elbows. Further, pipeline segments 104 extend for any distance and fluid conduit heating system 210 includes any number of microwave heating devices 200 that enable of fluid conduit heating system 210 as described herein. Moreover, as shown in FIG. 2, several microwave heating devices 200 are installed along plurality of pipeline segments 104 at intervals depending on the localized heating requirements and a length of pipeline segments 104. In alternative embodiments, fluid conduit heating system 210 and microwave heating devices 200 are used to heat other fluid conduit devices and components commonly used in subsea oil and gas recovery facilities, e.g., and without limitation, risers 106, jumpers 108, and piping couplers 110, and valves 112 (to reduce hydrate formation on the valves' seats, walls, and disks when open) (all shown in FIG. 1).

Also, in the exemplary embodiment, fluid conduit heating system 210 includes at least one controller 218 is coupled to each microwave heating device 200 through communications and power cabling 220. Communications and power cabling 220 is any cabling configured to operate in cold subsea environments. Alternatively, for those portions of fluid conduit heating system 210 not submerged, wireless communications are used. Controller 218 is configured with sufficient algorithms and instructions to enable fluid conduit heating system 210 to operate as described herein. For example, and without limitation, the power and frequency output of each microwave heating device 200 may be regulated by controller 218. Further, in the exemplary embodiment, piping segments 104 include a wall 221 including a radially inner surface 222 (discussed further below) and a radially outer surface 224 exposed to a subsea environment 226. In the exemplary embodiment, pipeline segments 104 are fabricated from a steel alloy, e.g., and without limitation, stainless steel alloys 304L, 316L, duplex, and AL-6×N. Alternatively, pipeline segments 104 are fabricated from any materials that enable operation of fluid conduit heating system 210 as described herein. At least some embodiments of subsea hydrocarbon fluid transfer system 100 and microwave-based fluid conduit heating system 210 include at least one layer of insulation (not shown) formed over pipeline segments 104 to facilitate heat retention within segments 104.

In operation, electromagnetic energy is generated outside pipeline segments 104 in the magnetron (not shown in FIG. 2) within microwave generator 202 and microwaves 216 are launched into pipeline segment 104 through waveguide 204 that is immersed in flow of wet natural gas 214. Microwaves 216 are confined inside pipeline segments 104 due to the metallic composition of radially inner surface 222 of wall 221 and propagate through pipeline segment 104. Microwaves 216 propagate inside wall 221 of natural gas pipeline segment 104 due to the relatively small attenuation features of the natural gas. The relatively small attenuation features are primarily due to most of the natural gas is methane (CH₄) (typically in excess of 95 mole percent (%)) which is a non-polar molecule and is substantially unaffected by microwaves 216. In contrast, microwaves 216 heat the small percentage of polar water molecules (typically less than 5%) mixed with the natural gas, thereby significantly altering the conditions within pipeline segments 104 away from those conditions favorable to the formation of hydrates. As such, the tendency for CH₄ molecules to bond with water molecules is significantly reduced due to the increased temperature of the water molecules. In addition to the small attenuation factors of the natural gas, transmission of microwaves 216 is further facilitated through portions of pipeline segments 104 that include bends and flow direction changes where radially inner surface 222 is used as a wave guide. As such, in some embodiments, microwave heating devices 200 are positioned above the sea level at an apex of risers 106, thereby facilitating ease of inspections and maintenance while facilitating launching of microwaves 216 through risers 106 downward toward pipeline segments 104.

Also, in operation, since pipeline segments 104 and fluid conduit heating system 210 are integrally configured such that of microwave heating devices 200 are installed at predetermined locations along the length of pipeline segments 104. As such, each microwave heating device 200 is operated at individualized power and frequency outputs (described further below) to facilitate operation as a function of the localized heating requirements of the associated pipeline segment 104. For example, and without limitation, those pipeline segments 104 in warmer water will consume less electric power than those pipeline segments 104 residing in colder water, thereby further facilitating more economical operation of fluid conduit heating system 210.

FIG. 3 is a schematic view of an alternative microwave-based fluid conduit heating system 310 that may be used with subsea hydrocarbon fluid transfer system 100 (shown in FIG. 1). In this alternative embodiment, a single pipeline segment 104 is shown. A microwave heating device 311 is coupled to a pipeline cleaning and inspection device, i.e., a pig 312. Pig 312 is configured to translate through pipeline segment 104 through motion induced by a flow of wet natural gas 314 through pipeline segment 104. Pig 312 is inserted into and retrieved from pipeline segment 104 through inlet and outlet ports or gates (not shown) defined in wall 221 of pipeline segment 104. Pig 312 is equipped with microwave heating device 311 aligned with radially inner surface 222 of pipeline segment 104 to conform a propagation pattern of microwave radiation 316 to a predetermined topography (not shown in FIG. 3 and discussed further below) of a radially inner surface 222 of pipeline segment 104. Pig 312 has any configuration that enables operation of fluid conduit heating system 310 as described herein. Further, pipeline segment 104 extends for any distance and fluid conduit heating system 310 includes any number of microwave heating devices 311 that enable of fluid conduit heating system 310 as described herein. At least some embodiments of subsea hydrocarbon fluid transfer system 100 and microwave-based fluid conduit heating system 310 include at least one layer of insulation (not shown) formed over pipeline segments 104 to facilitate heat retention within segments 104.

Also, in the exemplary embodiment, fluid conduit heating system 310 includes at least one controller 318 coupled to each microwave heating device 311 through communications and power cabling 320. Communications and power cabling 320 is any cabling configured to operate in cold subsea environments. Alternatively, for those portions of fluid conduit heating system 310 not submerged, wireless communications are used. Controller 318 is configured with sufficient algorithms and instructions to enable fluid conduit heating system 310 to operate as described herein. For example, and without limitation, the power and frequency output of each microwave heating device 311 may be regulated by controller 318. Furthermore, is some embodiments, controller 318 is configured to regulate operation of pig 312 to further enhance operation of fluid conduit heating system 310.

In operation, electromagnetic energy is generated outside pipeline segments 104 in a magnetron (not shown in FIG. 3) within a microwave generator 322 and microwaves 316 are launched into pipeline segment 104 through a waveguide 324 coupled to pig 312 that is immersed in, and propelled by flow of wet natural gas 314. Microwaves 316 are confined inside wall 221 of pipeline segments 104 due to the metallic composition of radially inner surface 222 and propagate through pipeline segment 104. Microwaves 316 propagate inside natural gas pipeline segment 104 due to the relatively small attenuation features of the natural gas. In addition to the small attenuation factors of the natural gas, transmission of microwaves 216 is further facilitated through portions of pipeline segments 104 that include bends and flow direction changes navigable by pig 312 where radially inner surface 222 is used as a wave guide. Fluid conduit heating system 310 is configured to reduce formation of hydrates and to remove exiting formations of hydrates.

Also, in operation, in this alternative embodiment, microwave heating device 311 is operated at predetermined power and frequency outputs (described further below) to facilitate operation as a function of the localized heating requirements along the length of pipeline segment 104. For example, and without limitation, those pipeline segments 104 in warmer water will consume less electric power than those pipeline segments 104 residing in colder water, thereby further facilitating more economical operation of fluid conduit heating system 210. Moreover, in some embodiments, sensors such as, and without limitation, cameras, temperature sensors, and pressure sensors are installed on pig 312 to facilitate, without limitation, visual inspections and local temperature and pressure monitoring for manual and/or automated adjustments of the settings of microwave heating device 311 at least partially as a function of the environmental measurements received therefrom. These features further enhance operation of fluid conduit heating system 310 during removal operations of existing hydrate deposits.

FIG. 4 is a schematic view of the principle of operation of microwave-based fluid conduit heating systems 210 and 310 (shown in FIGS. 2 and 3, respectively). Referring to FIGS. 2, 3, and 4, and as discussed above, in operation, electromagnetic energy is generated in a magnetron (not shown in FIGS. 2, 3, and 4) within a microwave generator 202/322 and microwaves 216/316 are launched into pipeline segment 104 through a waveguide 204/324 that is immersed in flow of wet natural gas 214/314. Microwaves 216/316 are confined inside wall 221 of pipeline segments 104 due to the metallic composition of radially inner surface 222 and propagate through pipeline segment 104. Microwaves 316 propagate inside natural gas pipeline segment 104, due to the relatively small attenuation features of the natural gas and the use of radially inner surface 222 as a wave guide, and interact with water molecules 330. Microwave heating devices 200/311 may be operated at predetermined power and frequency outputs to facilitate operation as a function of the localized heating requirements along the length of pipeline segment 104.

Moreover, in the exemplary embodiment shown in FIG. 4, pipeline segment 104 includes a predetermined surface topology for radially inner surface 222, i.e., internally corrugated topology with a plurality of ridges 340 having a predetermined periodicity in the direction of gas flow 214/314. In the exemplary embodiment, the internally corrugated topology with ridges 340 includes a plurality of substantially parallel ridges 340 extending circumferentially about radially inner surface 222, thereby defining a plurality of furrows 342 between ridges 340. For example, and without limitation, for a pipeline having an inner diameter measurement of 20.32 centimeters (cm) (8 inches (in.)), each ridge has a width of 1.74 cm (0.684 in.), each furrow has a width of 0.28 cm (0.11 in.), and each furrow has a depth of 0.45 cm (0.177 in.), such that each corrugation has a width W of 2.02 cm (0.794 in.) and the pipeline has approximately 50 corrugations per meter (m). Alternatively, pipeline segment 104 has any corrugation dimensions that enable operation of microwave-based fluid conduit heating systems 210 and 310 as described herein. Alternatively, the predetermined topology of radially inner surface 222 includes a plurality of substantially parallel ridges extending at least partially circumferentially and longitudinally about radially inner surface 222, thereby defining a substantially helical pattern.

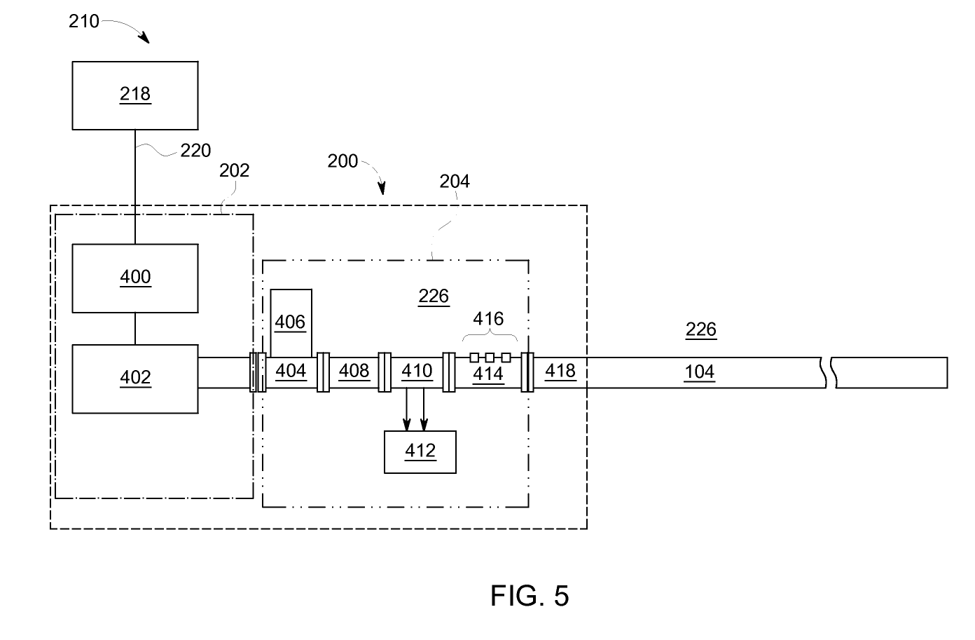

FIG. 5 is a schematic view of microwave heating device 200 that may be used with microwave-based fluid conduit heating system 210. In the exemplary embodiment, controller 218 is coupled to each microwave heating device 200 through communications and power cabling 220. Communications and power cabling 220 is any cabling configured to operate in cold subsea environments. Alternatively, for those portions of fluid conduit heating system 210 not submerged, wireless communications may be used. Controller 218 is configured with sufficient algorithms and instructions to enable fluid conduit heating system 210 to operate as described herein.

Microwave generator 202 includes a power supply 400 and a magnetron 402. Controller 218 is communicatively coupled to power supply 400 and magnetron 402, and power supply 400 is electrically coupled to magnetron 402, such that, without limitation, the power output and frequency output of microwave heating device 200 is regulated by controller 218. In the exemplary embodiment, power supply 400 and magnetron 402 are configured to generate at least 500 kilowatts (kW) of power. As described further below, output power and frequency may be regulated to regulate heat energy transmission within pipeline segment 104.

Waveguide 204 includes an isolator 404 coupled to magnetron 402. Isolator 404 facilitates launching forward microwave energy into pipeline segment 104 and substantially preventing reflective microwave power from returning to magnetron 402, thereby interrupting operation of magnetron 402 and potentially reducing the service life of magnetron 402. Waveguide 204 also includes a diode detector 406 coupled to isolator 404 to measure the output power of magnetron 402. Waveguide 204 further includes a variable attenuator 408 coupled to isolator 404 that provides microwave power attenuation control across a predetermined frequency range, thereby further facilitating regulation of heat energy transmission within pipeline segment 104. Waveguide 204 also includes directional coupler 410 coupled to variable attenuator 408 and coupled to a power meter 412. Directional coupler 410 and power meter 412 measure and display the amounts of forward power toward pipeline segment 104 and reflected power from pipeline segment 104. For those embodiments where waveguide 204 is submerged in subsea environment 226, the reflective power is dissipated in the water such that some circulating water removes the heat generated by the reflective power.

Waveguide 204 further includes a tuner 414 coupled to directional coupler 410. Tuner 414 includes a plurality of stub tuners 416 that match the impedance of microwave generator 202 with the impedance of pipeline segment 104, thereby facilitating enhancing the energy transfer from microwave generator 202 to pipeline segment 104. In the exemplary embodiment, tuner 414 includes three stub tuners 416. Alternatively, tuner 414 includes any number of stub tuners 416 that enables operation of waveguide 204 and fluid conduit heating system 210 as described herein. Impedance matching may be carried out manually, i.e., by an operator, or automatically by controller 218 by monitoring reflected power and adjusting the settings of tuner 414 to reduce reflected power and enhance forward power transmission to pipeline segment 104. Waveguide 204 further includes a waveguide-launch-to-pipe 418, sometimes referred to as an antenna, coupled to tuner 414 and that facilitates impedance to reduce the reflective power.

In the exemplary embodiment, as much of waveguide 204 is positioned above the surface of the water such that maintenance is facilitated. Also, portions of conduit 104 upstream of that portion of conduit 104 shown in FIG. 5 are not shown for clarity.

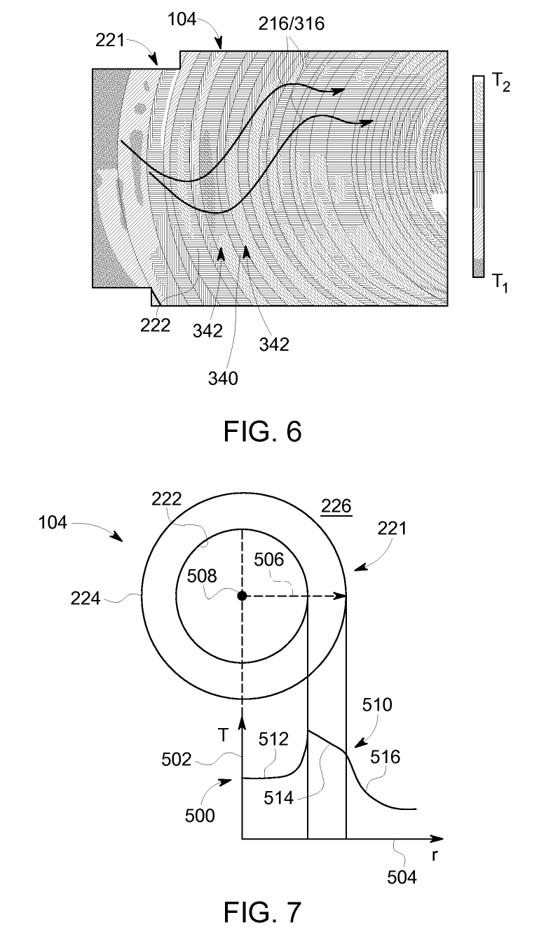

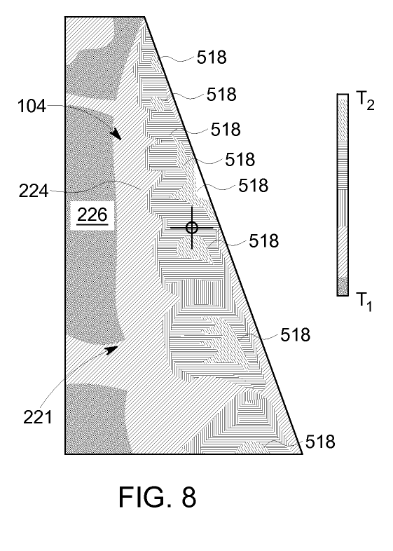

FIG. 6 is a thermographic view of a portion of radially inner surface 222 of a fluid transport conduit, i.e., pipeline segment 104 having the topography discussed above. FIG. 7 is a graphical view of a temperature profile of a cross-sectional view of pipeline segment 104. FIG. 8 is a thermographic view of a portion of radially outer surface 224 of pipeline segment 104.

Referring to FIG. 6, when metallic, corrugated pipeline segment 104 receives microwaves 216 launched from either of microwave heating devices 200 or 311 (shown in FIGS. 2 and 3, respectively), a temperature of radially inner surface 222 is increased as microwaves 216 interact with water molecules 330 and, due to surface corrugations 340/342 and the material (higher permeability steel) of radially inner surface 222, the microwave energy is dissipated in the pipeline segment 104. As the dissipated microwave energy heats wall 221 and facilitates prevention of hydrate formation by maintaining radially inner surface 222 temperature above a critical temperature associated with hydrate formation, i.e., approximately 25° C. (77° F.). At least some embodiments of subsea hydrocarbon fluid transfer system 100 and corrugated pipeline segment 104 include at least one layer of insulation (not shown) formed over pipeline segments 104 to facilitate heat retention within segments 104.

Referring to FIGS. 6, 7, and 8, in operation, as the temperature of radially inner surface 222 increases due to the deposition of microwave energy that has dissipated into heat energy as it is launched through pipeline segment 104 and interacts with water molecules 330, the deposited heat on radially inner surface 222 is transmitted through wall 221 to radially outer surface 224. This process is shown in FIG. 7 with a graph, i.e., a temperature profile 500 of a cross-sectional view of wall 221 of pipeline segment 104. Temperature profile 500 is shown against a y-axis 502 representative of temperature T within wall 221 without increments and units and an x-axis 504 representative of a radial distance r along a radial line 506 extending from a center 508 of pipeline segment 104 to radially outer surface 224. Temperature profile 500 also includes a curve 510 including a first segment 512 representing temperature within pipeline segment 104 from center 508 to radially inner surface 222 as the natural gas and water mixture are heated through microwaves 216 and the temperature of radially inner surface 222 increases. Curve 510 also includes a second segment 514 representing temperature within wall 221 between radially inner surface 222 and radially outer surface 224 that is steadily decreasing through wall 221 as the deposited heat energy is transmitted from the warmer surface 222 through wall 221 to the colder surface 224 that is surrounded by a large heat sink, i.e., subsea environment 226. Curve 510 further includes a third segment 516 representing temperature external to radially outer surface 224 in subsea environment 226 that asymptotically approaches the temperature of subsea environment 226.

Referring to FIG. 8, showing a thermographic view of a portion of radially outer surface 224 of pipeline segment 104, and FIG. 7, the temperature profile of radially outer surface 224 varies along the longitudinal extent of pipeline 104. In the exemplary embodiment, hot spots 518 in a periodical pattern have a temperature that is within a range of approximately 5° C. (9° F.) to 6° C. (11° F.) higher the temperature of subsea environment 226.

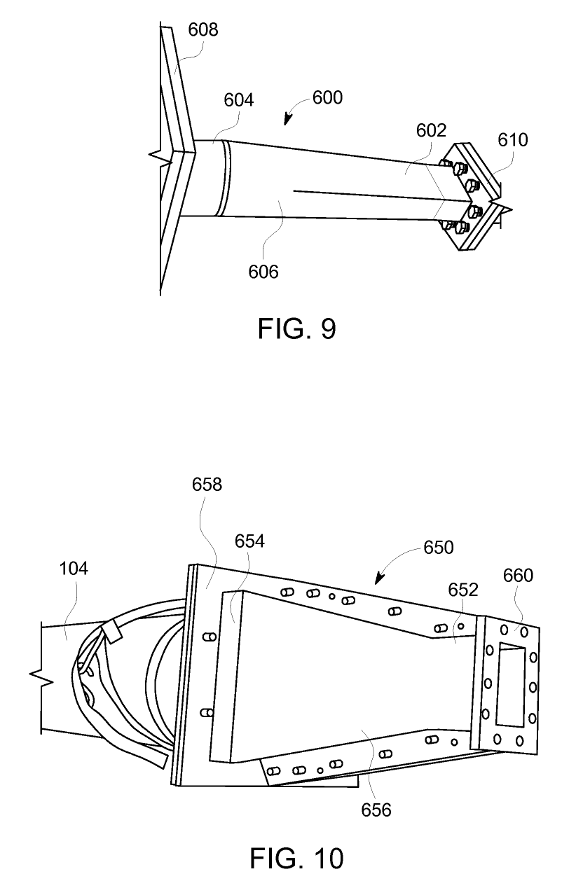

FIG. 9 is a schematic view of an exemplary waveguide mode converter 600 that may be used with the microwave-based fluid conduit heating systems 210 and 310 (shown in FIGS. 2 and 3, respectively). In the exemplary embodiment, waveguide mode converter 600 is configured to be coupled to pipeline segments 104 (shown in FIGS. 1, 2, 3, 4, 5, 7, and 8) having a diameter of approximately 6.35 centimeters (cm) (2.5 inches (in.)). Alternatively, waveguide mode converter 600 is configured to be coupled to pipeline segments 104 having any size diameter that enables operation of microwave heating devices 200 and 311 (shown in FIGS. 2 and 3, respectively). Waveguide mode converter 600 is also configured to facilitate launching microwaves 216 into pipeline segment 104. Waveguide mode converter 600 includes a substantially rectangular microwave inlet 602, a substantially circular microwave outlet 604, and rectangular-to-circular transition section 606 coupled to, and unitarily formed with, inlet 602 and outlet 604. Waveguide mode converter 600 also includes a coupling flange 608 configured to couple converter 600 to pipeline segment 104. Waveguide mode converter 600 further includes a coupling flange 610 configured to couple converter 600 to a rectangular waveguide (not shown).

Waveguide mode converter 600 facilitates transitioning microwaves 216 (shown in FIGS. 2, 4, and 6) from a rectangular waveguide to a circular waveguide, i.e., pipeline segment 104. Waveguide mode converter 600 also facilitates decreasing the amount of launched microwave power that would otherwise be reflected back toward microwave generator 202 (shown in FIGS. 1, 2, and 5).

Waveguide mode converter 600 further facilitates mode conversion. For example, and without limitation, microwave generator 202 may be a rectangular waveguide, generating in TE₁₀ (traverse electric) mode. Pipeline segment 104 is a circular waveguide with lower order modes such as TE₁₁, or, alternatively, TM₀₁ (traverse magnetic) mode, or TE₀₁ mode. In the transverse electric (TE) modes, the pattern of the electric field induced within pipeline segment 104 is substantially perpendicular to the longitudinal direction of microwave propagation along the length of segment 104 such that the top and bottom of segment 104 receives the majority of warming. Also, in the TE modes, substantially no longitudinal electric field components are generated and the magnetic field components also induced within pipeline segment 104 are oriented in the longitudinal direction. In the transverse magnetic (TM) modes, the pattern of the magnetic field induced within pipeline segment 104 is substantially perpendicular to the longitudinal direction of microwave propagation along the length of segment 104, and the electric field components also induced within pipeline segment 104 are oriented radially such that wall 221 (shown in FIGS. 2, 3, 4, 6, 7, and 8) of segment 104 is warmed in all directions.

The specific predetermined mode generated within pipeline segment 104 is selected based on various conditions. For example, and without limitation, the TE₁₁ mode can be coupled easily from a rectangular waveguide, leading to simplified mode converter design. However, the TM₀₁ mode has lower attenuation and is preferred to transfer energy over longer distances. Moreover, the TM₀₁ mode includes the electric field terminating on wall 221 in all directions, and may be preferred for evenly heating pipe walls. Furthermore, another factor that is considered when determining the mode to select is the cut-off frequency (discussed further below).

Therefore, in the exemplary embodiment, the “antenna” will be waveguide mode converter 600 that converts the TE₁₀ mode in the rectangular waveguide to TE₁₁ mode in the circular waveguide, i.e., pipeline segment 104 for efficient energy transfer from microwave generator 202 to pipeline segment 104. Also, in the exemplary embodiment, waveguide mode converter 600 facilitates aligning microwave heating device 200 with pipeline segment 104 to further conform the propagation pattern of the microwave radiation generated by microwave generator 202 to the predetermined topography of radially inner surface 222.

FIG. 10 is a schematic view of an alternative waveguide mode converter 650 that may be used with microwave-based fluid conduit heating systems 210 and 310 (shown in FIGS. 2 and 3, respectively). In the exemplary embodiment, waveguide mode converter 650 is configured to be coupled to pipeline segments 104 having a diameter of approximately 20.32 centimeters (cm) (8 inches (in.)). Alternatively, waveguide mode converter 650 is configured to be coupled to pipeline segments 104 having any size diameter that enables operation of microwave heating devices 200 and 311 (shown in FIGS. 2 and 3, respectively). Waveguide mode converter 650 is also configured to facilitate launching microwaves 216 into pipeline segment 104. Waveguide mode converter 650 includes a substantially rectangular microwave inlet 652, a substantially circular microwave outlet 654, and rectangular-to-circular transition section 656 coupled to, and unitarily formed with, inlet 652 and outlet 654. Waveguide mode converter 650 also includes a coupling flange 658 configured to couple converter 650 to pipeline segment 104. Waveguide mode converter 650 further includes a coupling flange 660 configured to couple converter 650 to a rectangular waveguide (not shown).

Waveguide mode converter 650 facilitates transitioning microwaves 216 (shown in FIGS. 2, 4, and 6) from a rectangular waveguide to a circular waveguide, i.e., pipeline segment 104. Waveguide mode converter 600 also facilitates decreasing the amount of launched microwave power that would otherwise be reflected back toward microwave generator 202 (shown in FIGS. 1, 2, and 5). Similar considerations for waveguide mode converter 600 as described above are used for waveguide mode converter 650. Also, in this alternative embodiment, waveguide mode converter 650 facilitates aligning microwave heating device 200 with pipeline segment 104 to further conform the propagation pattern of the microwave radiation generated by microwave generator 202 to the predetermined topography of radially inner surface 222.

In general, although not limited to any specific frequency, the heating will be carried out within pipeline segments 104 using frequencies typically at 900 megahertz (MHz), 2.45 gigahertz (GHz), or 5.8 GHz. The specific frequency will be selected based on the diameter of pipeline segment 104. For a given diameter, a specific frequency value is the cutoff frequency, i.e., for microwave frequencies below the cutoff frequency, propagation of the microwaves will be substantially hindered. Therefore, for the selected diameter, those microwave frequencies above the cutoff frequency will be selected. As an example, 2.45 GHz microwave frequency will be used for pipeline segments 104 with a diameter of 20.32 cm (8 in.) as shown in FIG. 10. However, for pipeline segments 104 with a diameter of 6.35 cm (2.5 in.), a microwave frequency of 5.8 GHz will be used. As such, the diameter of pipeline segment 104 and the operating cutoff frequencies of the microwave radiation launched into segment 104 are indirectly proportional such that the smaller the diameter, the higher the cutoff frequency. Furthermore, for a corrugated pipeline segment 104 having a diameter of 6.35 cm (2.5 in.), microwave attenuation at a microwave frequency of 5.8 GHz is approximately 0.167 decibels per meter (dB/m) and for corrugated pipeline segments 104 with a diameter of 20.32 cm (8 in.), microwave attenuation at a microwave frequency of 2.45 GHz is approximately 0.143 dB/m. Moreover, predetermined changes in the frequency of the launched microwaves at predetermined periodicities, i.e., frequency hopping, may also be used to conform the propagation pattern of the microwaves to enhance heat distribution in pipeline segments 104 with the associated diverse attenuation distances.

Referring to FIGS. 4, 6, 7, 8, 9, and 10, since pipeline segment 104 is internally corrugated, a change of the microwave frequency will result in a change of the proportion of heat being transferred to water molecules 330 inside pipeline segment 104 compared to the amount of heat transferred to the metallic inner part, i.e., radially inner surface 222. This feature can be used to transfer the heat where to where it is needed and when it is needed. Therefore, during operation, the frequency may be varied, while keeping above the associated cutoff frequency, to vary the heat energy added to pipeline segment 104 for predetermined distances. As described above, controllers 218 and 318 (shown in FIGS. 2 and 3, respectively) are used to regulate the frequencies of the microwave radiation.

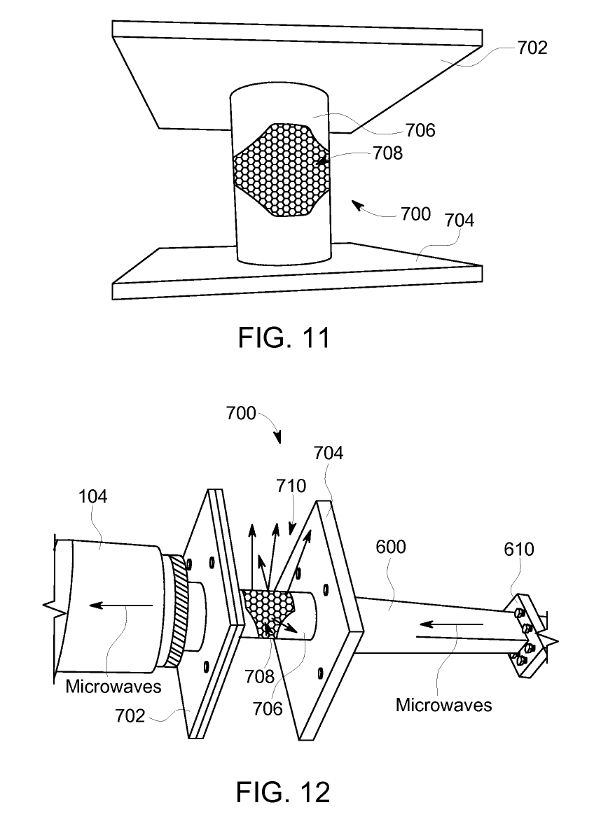

FIG. 11 is a schematic overhead view of an exemplary perforated waveguide 700 that may be used with microwave-based fluid conduit heating system 210 (shown in FIG. 2). FIG. 12 is a schematic perspective view of perforated waveguide 700. Perforated waveguide 700 includes a coupling flange 702 that facilitates coupling waveguide 700 to pipeline segment 104. Perforated waveguide 700 also includes a coupling flange 704 that facilitates coupling waveguide 700 to waveguide mode converter 600, that in turn is coupled to a rectangular waveguide (not shown) through coupling flange 610. Perforated waveguide 700 further includes a wall 706 that defines a plurality of perforations 708. Perforations 708 are sized, oriented, and configured to facilitate gas flow therethrough while maintaining the microwaves within waveguide 700 rather than permitting microwave leakage through perforations 708.

In operation, microwave energy can be continuously applied while there is a flow of wet natural gas 214 (shown in FIG. 2) through pipeline segment 104 to maintain radially inner surface 222 (shown in FIGS. 2, 3, 4, 6, 7, and 8) above the hydrate formation temperature that is typically 25° C. (77° F.). Also, in operation, microwaves may be launched when a blockage has formed (emergency application) in pipeline segment 104. Also, wet natural gas 214 is channeled through waveguide mode converter 600 to perforated waveguide 700. Natural gas 710 flows through perforations 708 and gas 710 exiting perforations 708 is channeled to another pipeline through any conduit devices that enable operation of microwave-based fluid conduit heating system 210 as described herein.

Perforated waveguide 700 and waveguide mode converter 600 facilitate placing microwave heating devices 200 as shown in FIG. 2 further within conduit 104, thereby reducing a need for flow diverters 212. As discussed further below, such configurations increase the flexibility of piping configurations that can receive and benefit from microwave heating as described herein.

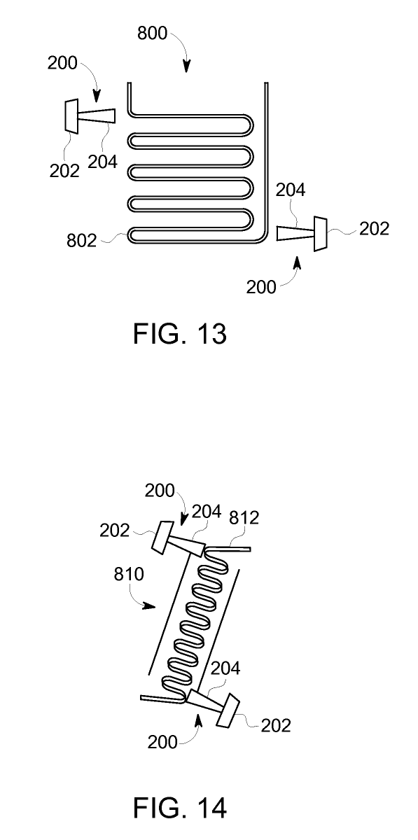

FIG. 13 is a schematic view of an exemplary heat exchange device, i.e., an anti-surge cooler 800 that may be used with subsea hydrocarbon fluid transfer system 100 (shown in FIG. 1). During operation of gas compressors (not shown) used to pressurize the gas to be transported through pipeline segments 104 (shown in FIG. 4), compressor surge may occur, where the affected compressor is pulling in gas faster than it is expelling it, the pressure in the compressor rises inducing the compressor to slow down until a near instantaneous release of the trapped gas induces a rapid acceleration of the affected compressor, thereby repeating the cycle of surging. As such, many gas compressors include an anti-surge system (not shown) configured to provide a path of gas to exit from the compressor and be recirculated back to the inlet of the compressor to restore flow from the compressor as quickly as possible. Some such anti-surge systems include an anti-surge cooler, such as anti-surge cooler 800 to remove heat from the compressed gas prior to recirculation to the compressor inlet to control the suction temperature of the gas and thereby facilitate preventing the compressor from going into surge.

Anti-surge cooler 800 includes at least one tube 802 that provides a tortuous path for the gas to travel to increase the surface area of exposure and heat transfer. Tubes 802 include a radially inner tube surface (not shown) having a predetermined, i.e., corrugated topography similar to the predetermined topography of radially inner conduit surface 222 (shown in FIG. 4) for pipeline 104. During operation of the compressors, wet natural gas is transported. Such wet natural gas is recirculated through anti-surge cooler 800, therefore tube 802 is exposed to the same wet natural gas as is pipeline segments 104, and is therefore subject to formations of hydrate deposits on the inner surfaces of tubes 802. Microwave heating devices 200 launch microwaves through tube 802 to heat the internal wall surfaces in tube 802 while gas is transported therethrough. In FIG. 13, microwave heating devices 200 are shown schematically detached from tube 802. However, microwave heating devices 200 are coupled to tube 802 through mechanisms that include, without limitation, perforated waveguide 700 (shown in FIGS. 11 and 12) such that the gas exits perforated waveguide 700 in a direction substantially perpendicular to the direction and orientation of pipe 802 at the point where waveguide 700 is coupled thereto, and the gas will then be directed toward the appropriate connections of anti-surge cooler 800.

FIG. 14 is a schematic view of an alternative heat exchange device, i.e., an anti-surge cooler 810 that may be used with subsea hydrocarbon fluid transfer system 100 (shown in FIG. 1). Anti-surge cooler 810 includes at least one tube 812 that provides a tortuous path for the gas to travel to increase the surface area of exposure and heat transfer. Tubes 812 include a radially inner tube surface (not shown) having a predetermined, i.e., corrugated topography similar to the predetermined topography of radially inner conduit surface 222 (shown in FIG. 4) for pipeline 104. Microwave heating devices 200 launch microwaves through tube 812 to heat the internal wall surfaces in tube 812 while gas is transported therethrough. In FIG. 14, microwave heating devices 200 are shown schematically detached from tube 812. However, microwave heating devices 200 are coupled to tube 812 through mechanisms that include, without limitation, perforated waveguide 700 (shown in FIGS. 11 and 12) such that the gas exits perforated waveguide 700 in a direction substantially perpendicular to the direction and orientation of pipe 812 at the point where waveguide 700 is coupled thereto, and the gas will then be directed toward the appropriate connections of anti-surge cooler 810.

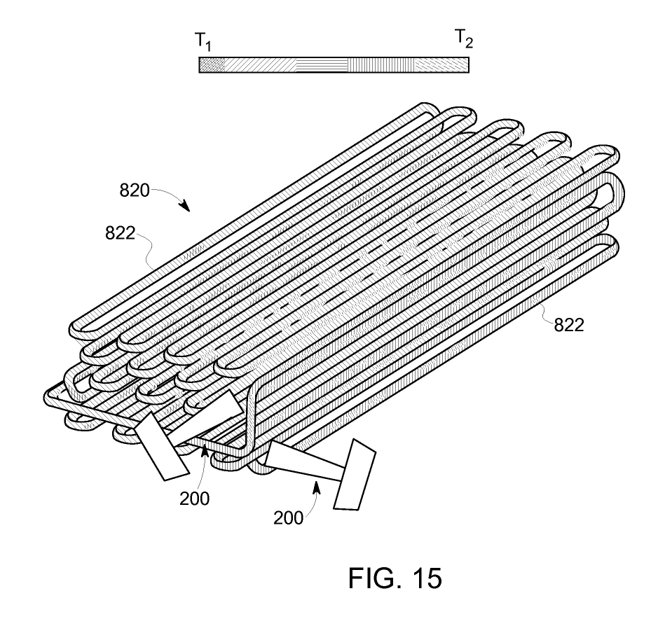

FIG. 15 is a schematic view of another alternative heat exchange device, i.e., an anti-surge cooler 820 that may be used with subsea hydrocarbon fluid transfer system 100 (shown in FIG. 1). Anti-surge cooler 820 includes at least one tube 822 that provides a tortuous path for the gas to travel to increase the surface area of exposure and heat transfer. Tubes 822 include a radially inner tube surface (not shown) having a predetermined, i.e., corrugated topography similar to the predetermined topography of radially inner conduit surface 222 (shown in FIG. 4) for pipeline 104. Microwave heating devices 200 launch microwaves through tube 822 to heat the internal wall surfaces in tube 822 while gas is transported therethrough. In FIG. 15, microwave heating devices 200 are shown schematically detached from tubes 822. However, microwave heating devices 200 are coupled to one or more of tubes 822 through mechanisms that include, without limitation, perforated waveguide 700 (shown in FIGS. 11 and 12) such that the gas exits perforated waveguide 700 in a direction substantially perpendicular to the direction and orientation of pipes 822 at the point where waveguide 700 is coupled thereto, and the gas will then be directed toward the appropriate connections of anti-surge cooler 820.

The configurations of microwave heating devices 200 associated with anti-surge coolers 800, 810, and 820 are applicable for heating other metallic components commonly used in subsea oil and gas recovery facilities, e.g., and without limitation, other portions of manifold 102 such as risers 106, jumpers 108, and piping couplers 110, and valves 112 (to reduce hydrate formation on the valves' seats, walls, and disks when open) (all shown in FIG. 1).

The above described microwave heating devices, fluid conduit heating systems, and subsea hydrocarbon fluid transfer systems overcome a number of deficiencies associated with known systems and methods of reducing restrictions in subsea natural gas pipelines in low temperature environments, e.g., arctic regions. Specifically, the fluid conduit heating systems use microwaves to heat water molecules in natural gas pipelines thus decreasing formation of hydrates in the pipelines. The microwaves propagate along the pipeline that includes predetermined inner wall surface topologies, e.g., configured with internal corrugations or substantially helical patterns, from a microwave heating device, either mobile or fixed, that is immersed in the fluid being transported. The metallic pipeline acts as an electromagnetic wave guide keeping the microwaves confined into the inner region of the pipeline, transporting the heating energy to the predetermined heating points, and facilitating microwave transmission through bends and other flow direction changes. The microwaves travel along the pipeline and heat the water molecules and the inner surface of the metallic pipeline. The heated polar water molecules cannot bond into the unheated, nonpolar methane molecules and the formation of hydrates is significantly reduced.

Also, the fluid conduit heating systems described herein facilitate decreasing capital construction costs and operation and maintenance costs. For example, heating cables are not coupled to the length of the pipeline segments to be heated, a significant decrease in energy transfer to the surrounding subsea environment is achieved, there is little chance for inducing secondary currents outside of the pipeline in the subsea environment, operation of natural gas pipelines in more severe cold operating conditions, such as sea floor pipelines under arctic conditions. In addition, design and operation of the heating systems described herein may be customized to facilitate particular environmental conditions at energy consumption levels particular to local heating requirements.

An exemplary technical effect of the methods, systems, and apparatus described herein includes at least one of: (a) decreasing hydrate deposition on the inner wall surfaces of natural gas pipelines in cold subsea conditions through an integrated combination of microwave launching into the pipeline at predetermined frequencies and modes and the internal topologies of the pipeline; (b) increasing the energy efficiency of fluid conduit heating systems through targeted microwave launching internal to the pipeline to heat the water molecules and the internal surfaces of the pipeline with reducing heat transfer into the subsea environment; and (c) decreasing capital construction costs through elimination of external cabling and wrapping extending the substantial lengths of the pipeline.

Exemplary embodiments of microwave heating devices, fluid conduit heating systems, and subsea hydrocarbon fluid transfer systems are described above in detail. The microwave heating devices, fluid conduit heating systems, and subsea hydrocarbon fluid transfer systems, and methods of operating such systems and devices are not limited to the specific embodiments described herein, but rather, components of systems and/or steps of the methods may be utilized independently and separately from other components and/or steps described herein. For example, the systems, apparatus, and methods may also be used in combination with other systems requiring efficient directed microwave heating capabilities, and are not limited to practice with only the facilities, systems and methods as described herein. Rather, the exemplary embodiment can be implemented and utilized in connection with many other heating applications that are configured to transport wet fluids that tend to form hydrate deposits, e.g., and without limitation, subsea oil and gas recovery facilities and oil and gas refining facilities.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

Some embodiments involve the use of one or more electronic or computing devices. Such devices typically include a processor, processing device, or controller, such as a general purpose central processing unit (CPU), a graphics processing unit (GPU), a microcontroller, a reduced instruction set computer (RISC) processor, an application specific integrated circuit (ASIC), a programmable logic circuit (PLC), a field programmable gate array (FPGA), a digital signal processing (DSP) device, and/or any other circuit or processing device capable of executing the functions described herein. The methods described herein may be encoded as executable instructions embodied in a computer readable medium, including, without limitation, a storage device and/or a memory device. Such instructions, when executed by a processing device, cause the processing device to perform at least a portion of the methods described herein. The above examples are exemplary only, and thus are not intended to limit in any way the definition and/or meaning of the term processor and processing device.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A fluid conduit heating system comprising:
a fluid transport conduit comprising a wall comprising a radially inner surface and a radially outer surface, said radially inner surface having a predetermined topography, said fluid transport conduit configured to transport a hydrocarbon fluid therethrough; and
a microwave heating device in radio frequency (RF) communication with said fluid transport conduit, said microwave heating device comprising:
a microwave generator configured to generate microwave radiation; and
a waveguide coupled to said microwave generator, said waveguide configured to conform a propagation pattern of the microwave radiation generated by said microwave generator to said predetermined topography of said radially inner surface.

2. The fluid conduit heating system in accordance with claim 1, wherein said predetermined topography of said radially inner surface comprises a corrugated topology comprising a plurality of ridges having a predetermined periodicity.

3. The fluid conduit heating system in accordance with claim 2, wherein said plurality of ridges having a predetermined periodicity comprises a plurality of substantially parallel ridges extending circumferentially about said radially inner surface.

4. The fluid conduit heating system in accordance with claim 1, said microwave heating device is aligned with said fluid transport conduit to further conform the propagation pattern of the microwave radiation generated by said microwave generator to said predetermined topography of said radially inner surface.

5. The fluid conduit heating system in accordance with claim 1, wherein said waveguide comprises a wall, said waveguide coupled in flow communication with a source of hydrocarbon fluid, said wall comprises at least one opening defined therein configured to channel the hydrocarbon fluid from said waveguide to said fluid transport conduit.

6. The fluid conduit heating system in accordance with claim 5, wherein said at least one opening comprises a plurality of perforations defined within said wall, said plurality of perforations configured to facilitate capturing the microwave radiation within said waveguide to further facilitate launching the microwave radiation into said fluid transport conduit.

7. The fluid conduit heating system in accordance with claim 1, wherein said microwave heating device is configured as a mobile system coupled to a pipeline pig.

8. A method of deposit removal and deposit inhibition in a fluid transport conduit including a wall including a radially inner surface having a predetermined topography, the fluid transport conduit configured for subsea operation and further configured to transport a hydrocarbon fluid therethrough, said method comprising:
coupling a microwave heating device in radio frequency (RF) communication with the fluid transport conduit;
generating microwave radiation through the microwave heating device;
conforming a propagation pattern of the microwave radiation generated by the microwave heating device to the predetermined topography of the radially inner surface; and
launching the microwave radiation into the fluid transport conduit.

9. The method in accordance with claim 8 further comprising configuring the predetermined topography of the radially inner surface with a corrugated topology including a plurality of ridges having a predetermined periodicity.

10. The method in accordance with claim 9, wherein configuring the predetermined topography further comprises configuring the plurality of ridges with a predetermined periodicity including a plurality of substantially parallel ridges extending circumferentially about the radially inner surface.

11. The method in accordance with claim 8 further comprising aligning the microwave heating device with the fluid transport conduit to further conform the propagation pattern of the microwave radiation to the predetermined topography of the radially inner surface.

12. The method in accordance with claim 8, wherein the microwave heating device includes a microwave generator configured to generate the microwave radiation and a waveguide coupled to the microwave generator, the waveguide includes a wall, said method further comprising:
defining at least one opening in the wall;
coupling the waveguide in flow communication with a source of hydrocarbon fluid; and
channeling the hydrocarbon fluid from the source of hydrocarbon fluid to the fluid transport conduit through the waveguide.

13. The method in accordance with claim 12, wherein defining at least one opening in the wall comprises:
defining a plurality of perforations within the wall; and
configuring the plurality of perforations to facilitate capturing the microwave radiation within the waveguide to further facilitate launching the microwave radiation into the fluid transport conduit.

14. The method in accordance with claim 8 further comprising:
coupling the microwave heating device to a pipeline pig; and
translating the pipeline pig through the fluid transport conduit.

15. The method in accordance with claim 14 further comprising:
coupling at least one sensor to the pipeline pig; and
adjusting operation of the microwave heating device as at least partially as a function of environmental measurements received from the at least one sensor.

16. The method in accordance with claim 8, wherein launching the microwave radiation into the fluid transport conduit comprises increasing a temperature of the radially inner surface.

17. The method in accordance with claim 8, wherein launching the microwave radiation into the fluid transport conduit comprises increasing a temperature of the hydrocarbon fluid.

18. The method in accordance with claim 8, wherein conforming a propagation pattern of the microwave radiation comprises regulating the frequency of the launched microwave radiation at predetermined periodicities at predetermined frequencies.

19. A subsea hydrocarbon fluid transfer system comprising:
a plurality of fluid transport conduits coupled in flow communication, each fluid transport conduit of said plurality of fluid transport conduits comprising a conduit wall comprising a radially inner conduit surface and a radially outer conduit surface, said radially inner conduit surface having a predetermined topography, said each fluid transport conduit configured to transport a hydrocarbon fluid therethrough; and
a microwave-based fluid conduit heating system comprising:
a plurality of microwave heating devices in radio frequency (RF) communication with at least a portion of said fluid transport conduits, each microwave heating device of said plurality of microwave heating devices comprising:
a microwave generator configured to generate microwave radiation; and
a waveguide coupled to a respective said microwave generator, said waveguide configured to conform a propagation pattern of the microwave radiation generated by said respective microwave generator to said predetermined topography of said radially inner conduit surface.

20. The subsea hydrocarbon fluid transfer system in accordance with claim 19, wherein said plurality of fluid transport conduits comprises at least one subsea heat exchanger comprising a plurality of tubes, each tube of said plurality of tubes comprising a radially inner tube surface having a predetermined topography similar to said predetermined topography of said radially inner conduit surface, said each tube configured to transport a hydrocarbon fluid therethrough.

21. The subsea hydrocarbon fluid transfer system in accordance with claim 20, wherein said plurality of fluid transport conduits further comprises one or more of piping risers, manifolds, jumpers, piping couplers, and valves.
